(19) United States
(12) Patent Application Publication
(10) Pub. No.: US 2011/0020523 A1
(43) Pub. Date: Jan. 27, 2011

(54) Method for Preparing a Low Viscosity Whole Grain Flour Slurry Via Mechanical Treatment

(75) Inventors: Ricardo Pereyra, White Plains, NY (US); William Mutilangi, Peekshill, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo, Inc., Purchase, NY (US)

(21) Appl. No.: 12/878,251

(22) Filed: Sep. 9, 2010

Related U.S. Application Data
(63) Continuation-in-part of application No. 12/173,452, filed on Jul. 15, 2008.

(51) Int. Cl. B01F 3/12; A23L 2/38; A23C 9/154; A23L 2/02; A23C 11/10

(52) U.S. Cl. 426/580; 426/506; 426/590; 426/599; 426/598

(57) ABSTRACT

A method for preparing a low viscosity whole grain flour slurry including hydrating whole grain flour in water and subjecting the flour-water mixture to mechanical treatment to obtain a low viscosity whole grain flour slurry.

### CROSS-REFERENCE TO RELATED APPLICATIONS

This application is a continuation-in-part of U.S. Non-Provisional patent application Ser. No. 12/173,452 filed on Jul. 15, 2008 the disclosure of which is expressly incorporated herein by reference in its entirety.

### FIELD OF THE INVENTION

The present invention relates generally to preparation of flour slurry. More particularly, the present invention relates to a method for preparing low viscosity whole grain flour slurry via mechanical treatment.

### BACKGROUND

Due to high cholesterol, obesity, and heart disease concerns, many consumers are interested in making healthier choices about their diets. For this reason, a need exists to provide consumers with whole grain, low cholesterol products. In recent years there has been a growing awareness and demand for nutritional products in the food industry. This demand has been addressed through several strategies: a boost in fiber, reduction in calories, addition of good fats (omega-3 and essential fatty acids), and removal of unhealthy ingredients. One class of nutritional food products is whole grains. Whole grain products are typically low in fat, some have been shown to lower cholesterol, contain polyunsaturated fat, protein and minerals, and provide other physiological benefits.

The nutritional value and health benefits of whole grains, particularly whole grain oats, are well known. Compared to other cereals, oats have several nutritional advantages. Cell walls, located in the aleurone layer and partially in the endosperm. have a high concentration of B-glucan. Besides the benefits related to the intake of cereal dietary fibers, B-glucan is strongly linked to the attenuation of postprandial glycemic response and to the reduction of serum cholesterol levels. Several national authorities have acknowledged the health benefits of B-glucan. The US FDA has allowed a heart health claim on the label of product that provides at least 0.75 g of B-glucan per serving. In Finland, Sweden, and the United Kingdom, authorities have also approved health claims related to oats. In beverages, the cholesterol-lowering properties of B-glucan have been reported. It was demonstrated that 5 g of B-glucan delivered in 500 ml of fruit juice was able to reduce total and LDL cholesterol in healthy individuals.

Historically, the common source of grains and fibers has been in the form of breads, breakfast cereals, and pasta. The most important traditional oat products are oat porridge and RTE cereals including different types of muesli. The use of whole grains has been less successful in beverages due to the insolubility of the whole grain, inability to mask the texture, and the undesirable viscosity buildup of the flour after hydration which makes it very difficult to process and consume.

Although others have attempted to make drinkable whole grain products, the texture and properties, such as sliminess, thick viscosity and mouthfeel, of the resultant products are undesirable. These undesirable characteristics are, in large part, attributable to the thick viscosity of the whole grain slurries used in preparing the products. Therefore, a need exists for a low viscosity whole grain flour slurry and method for preparing same.

Methods traditionally used in the field to reduce viscosity of whole grain flour slurries include subjecting the flour slurry to a colloid mill and adding an enzyme to the whole grain flour slurry. Both of these methods have significant drawbacks. For example, using a colloid mill to lower the viscosity of a whole grain flour slurry is extremely time consuming, as the slurry must be treated with the colloid mill for at least 45 minutes. Adding an enzyme to the flour-water slurry to reduce the viscosity is also extremely disadvantageous, as these enzymes must be purchased or manufactured at a significant cost. Moreover, the enzyme hydrolyzes the starch flour thereby modifying the structure of the flour which in turn causes the flour to lose its standard of identity as “whole grain”. If the flour loses its standard of identity as “whole grain” one cannot make particular FDA-approved health claims relating to the flour.

The present invention is directed toward satisfying the need that exists in the field, for a cost-effective and time-effective method for preparing a low viscosity whole grain flour slurry. The present invention reduces the viscosity of a whole grain flour-water mixture at least three-fold over standard processes. Additionally, when used in a beverage, this reduced viscosity whole grain slurry will provide consumers with a healthy and easily consumable product with enhanced texture and drinkability.

### BRIEF SUMMARY

One aspect of the present invention is directed to preparing a flour-water mixture and subsequently subjecting the mixture to mechanical treatment, such as emulsification, to obtain low viscosity whole grain flour slurry.

Another aspect of the present invention relates to a beverage comprising the low viscosity whole grain flour.

### DETAILED DESCRIPTION OF THE DRAWINGS

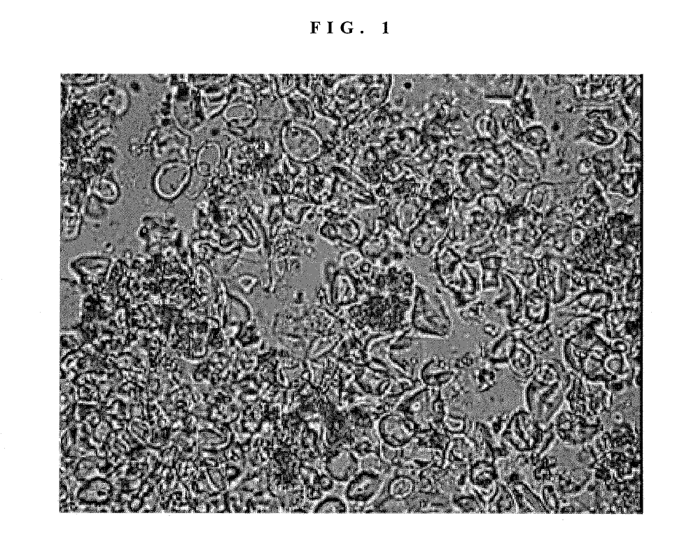

FIG. 1 shows a micrograph of whole grain oat flour at 80° C. after high shear treatment using a high shear emulsifier.

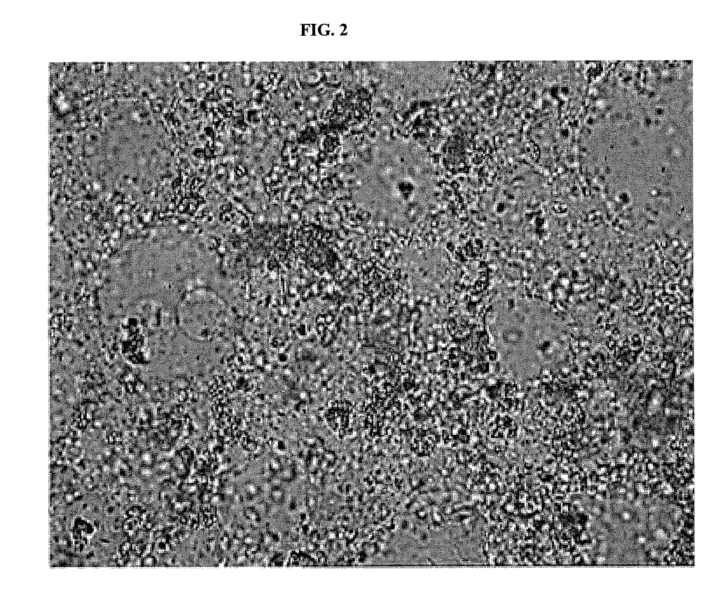

FIG. 2 shows a micrograph of whole grain oat flour at 95° C. after high shear treatment using a high shear emulsifier.

### DETAILED DESCRIPTION OF THE INVENTION

It was discovered that whole grain flour slurry with a low viscosity is useful in many applications, in particular, for use in foods and beverages. Thus the present invention relates to a method for preparing low viscosity whole grain flour slurry by subjecting flour-water slurry to mechanical treatment.

The whole grain flour may be derived from oats, barley, wheat, quinoa, corn, or mixtures of any of these grains, although one of ordinary skill in the art would recognize that flours derived from other whole grains may also be used in accordance with the present invention. The flours may be present in various combinations and in various amounts, in accordance with the present invention.

“Low viscosity” as used herein means less than about 200 cP when measured at a temperature of about 158° F. with a Brookfield RVDV-F rotational viscometer. Ideally the viscosity is less than about 150 cP, such as between about 60-16 cP.

A flour to water ratio of about 1:1 to about 1:50 may be used to obtain the flour-water mixture. For example, the flour to water ratio may be about 1:8 to about 1:20. Any suitable amounts of flour and water are contemplated, but generally about 1% to about 50% whole grain flour may be added to about 50% to about 99% water. More specifically, about 5% to about 11% whole grain flour may be added to about 89% to about 95% water. In one aspect, 8% whole grain flour may be added to 92% water.

Flour and water are combined and mixed in any suitable manner to form a slurry. The temperature of the water is typically from 80° C. to 99° C., more typically from 90° C. to 98° C. to help hydrate the flour, and in particular from 94° C. to 96° C. The pH of the slurry is typically about 5 to 7.5, for example, about 6.4.

The slurry is subjected to mechanical treatment to reduce the viscosity of the slurry. Mechanical treatments include mixing, emulsifying, milling and agitating under high shear. For example a high shear emulsifier having a rotor tip speed of about 35 m/s and a shear energy above 350,000 W/kg may be used. In one aspect of the invention a rotor tip speed of about 70 m/s and a shear energy of about 5,000,000 W/kg is used.

The low viscosity whole grain flour slurries may be added to any suitable beverage such as dairy beverages, juice beverages, soy beverages, teas, coffees, energy drinks, meal replacements, and protein drinks. The beverage may contain any suitable amount of whole grain, for example between about 0.1 and 20 grams whole grains per 8 oz serving. Typically 8 grams and 16 grams of whole grain oats are provided per serving (8 oz).

After combining the slurry with the beverage, the beverage may be pasteurized and/or homogenized in accordance with standard procedures.

### EXAMPLE

A first homogenous whole grain oat flour/water slurry was prepared by dispersing and hydrating flour in water using a Scott Turbon Mixer LA-1 (Adelanto, Calif.). The resulting slurry was then treated using a rotor/stator emulsifier, such as the NSF Quadro HV-E (Waterloo, ON) at 60 gallons per minute, 5500 RPM at 65 m/second.

A second whole grain oat flour/water slurry was prepared by dispersing, hydrating, and treating flour in water using a colloid mill, such as a Chemineer CM14 750-H (Amherst, Mass.) with an adjustable rotor-stator gap.

The whole grain oat flour was dispersed in 95° C. water to achieve a final concentration of flour in water of 7.7%. Each slurry was agitated for 20 minutes at 95° C. until fully pasted. The pasted slurries at 95° C. were re-circulated between a steam jacketed kettle and a colloid mill at gap setting of 8 for 90 minutes. Identical slurries were separately re-circulated and high sheared between a steam jacketed kettle and a high shear emulsifier.

The particle size of slurries and finished product was determined using a Malvern Mastersize 2000 LASER defractor (Particle Size Labs, Downers Grove, Ill.).

The apparent viscosity of each slurry was measured using a Brookfield RVDV-F rotational viscometer (Middleboro, Mass.). Four hundred ml of each sample was treated with a high shear emulsifier, colloid mill, or control were separated and equilibrated at 70° C. Apparent viscosity was measured at 70° C., 30 RPM. Viscosity of finished whole grain oat beverages was measured at 25° C., 30 RPM.

Low-acid dairy-based beverages were prepared with the whole grain oat flour slurries treated with a colloid mill and a high shear emulsifier to provide 8 and 16 grams of whole grain oats per serving (8 oz). Formulas for whole grain oat beverages using high shear whole grain oat flour slurries made in accordance with the present invention are included in Table 1

TABLE 1

| Ingredients | 8 grams | 16 grams |
|---|---|---|
| Oat Flour Slurry | 43% | 86% |
| Condensed Milk | 8.1% | 6.1% |
| Sucrose | 7% | 7% |
| Stabilizers | 0.2% | 0.2% |

Beverage formulas containing the treated slurries were pasteurized using steam injection, held at 140° C. for 3.5 seconds for a minimum Fo=8.5 (equivalent heat exposure time) using a Tetrathenn Aseptic (Tetrapak. Chicago, Ill.). Samples were homogenized at 75° C. with an inline aseptic two stage homogenizer (TetraPak SI-IL 20) for a total pressure of 3000 psi. The resulting product was cooled down to 28° C. and packaged using 240 mL TetraBrik 6 layer cartons.

Peak viscosity of whole grain oat flour slurry was achieved at 95° C., suggesting optimal hydration or pasting temperature. Treatment at 95° C. was more effective at reducing particle size of the oat slurry than treatment at 80° C., and no changes in the starch structure were evident until heat was applied. It is believed that the combination of heat and water causes uncooked starch granules present in the oat flour to undergo unique and irreversible changes which are 1) transition from the crystalline to the “pasting” (full hydration) state due to the disruption of hydrogen bonds between starch molecules; and 2) increase in granule size. As these changes are taking place, there is an increase in the viscosity of the flour solution. As heating continues and more granules become fully hydrated, the viscosity of the solution increases. The maximum viscosity of the solution is achieved when the largest percentage of granules is fully hydrated, and this is referred to as peak viscosity.

The particle sizes of whole grain oat flour slurries (7.5 wt %) treated with a colloid mill and a high shear emulsifier were significantly lower than the control. The control slurry is a water and flour solution using a Scott Turbon mixer to disperse the flour in the hot water. High shear emulsifier produced slurries with smaller particle size than both the colloid mill and control (Table 2, FIGS. 1, 2). There is a strong correlation (RSQ=0.988) between particle size and viscosity (cP, 30 RPM, 70° C.).

TABLE 2

| | Particle | Viscosity | |
|---|---|---|---|
| | size (gm) | (cP) | T index |
| High shear | 42.11 | 67 | 1.08 |
| emulsifier | | | |
| Colloid Mill | 59.31 | 155 | 1.12 |
| Control | 91.61 | 420 | 1.85 |

Finished products containing the slurry treated with a high shear emulsifier had smaller particle size and lower viscosity. See Table 3.

TABLE 3

| | Particle Size | Viscosity | |
|---|---|---|---|
| | (μm) | (cP) | T index |
| 8 g colloid mill | 92.24 | 129 | 1.48 |
| 16 g colloid mill | Nd* | Nd | Nd |
| 8 g high shear emulsifier | 86.16 | 110 | 1.37 |
| 16 g high shear emulsifier | Nd | 410 | 1.68 |

*Nd as used in the table above means “no data”

Viscosity of slurries was measured at 70° C. to prevent gelation of control slurry. The T index shows control slurry is moderately pseudoplastic (shear-thinning) and non-Newtonian. Liquids or fluids whose viscosities are not affected by changes in the shear rate are Newtonian. Perfectly Newtonian liquids have a thin index equal to 1. Many other liquids show viscosity decreases when the shear rate is increased from low to high levels (shear thinning effect), and are called pseudoplastic. Pseudoplastic behavior may facilitate transport of untreated slurry by requiring less force (pressure) to pump the slurry at higher speed due to lowered viscosity at higher shear rates. This is particularly important when producing large amounts of slurry that need to be pumped from steam jacketed kettles to high shear equipment. The viscosity of treated slurries is significantly lower and less pseudoplastic than the control (Table 3), suggesting a lower starch molecular weight and smaller particle size of the starch molecules as a result of treatments.

The inventors also found that by using a high shear emulsifier as described herein, they were able to reduce the viscosity of slurries to about 200 cP or less about 9 times faster than compares to a colloid mill. For instance, the high shear emulsifier may have a top rotor tip speed of about 70 m/s and a shear energy of 5,000,000 W/kg. Finished products containing slurry treated with a high shear emulsifier had lower viscosity and were less pseudoplastic than products containing slurry treated with a colloid mill. The viscosity of finished products containing 16 grams of oats using slurries treated with colloid mill could not be measured because slurries were too viscous to process.

As described, the present invention provides a method for preparing a low viscosity whole grain flour slurry via mechanical treatment, with beneficial attributes and various applications in the food industry and other industries.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for preparing a low viscosity whole grain flour slurry comprising:
a) fully dispersing whole grain flour in water at a ratio of about 1:1 to about 1:50 to obtain a flour-water mixture; and
b) subjecting the flour-water mixture to high shear treatment to obtain a low viscosity whole grain flour slurry.

2. The method of claim 1 further comprising fully dispersing the whole grain flour in water at a temperature of from 90° C. to 98° C.

3. The method of claim 2 wherein the temperature is from 94° C. to 96° C.

4. The method of claim 1 wherein the high shear treatment is performed using a high shear emulsifier.

5. The method of claim 4 wherein the high shear emulsifier has a rotor tip speed of about 70 m/s and a shear energy of about 5,000,000 W/kg.

6. The method of claim 1 wherein the flour to water ratio may be about 1:8 to about 1:20.

7. A low viscosity whole grain slurry prepared by
a) fully dispersing whole grain flour in water at a ratio of about 1:1 to about 1:50 to obtain a flour-water mixture; and
b) subjecting the flour-water mixture to high shear treatment to obtain a low viscosity whole grain flour slurry.

8. The slurry of claim 7 wherein the flour to water ratio may be about 1:8 to about 1:20.

9. The slurry of claim 7 wherein the whole grain flour is whole oat flour.

10. The slurry of claim 7 wherein the high shear treatment is emulsification.

11. A beverage comprising a beverage base and a low viscosity whole grain slurry prepared by
a) fully dispersing whole grain flour in water at a ratio of about 1:1 to about 1:50 to obtain a flour-water mixture; and
b) subjecting the flour-water mixture to high shear treatment to obtain a low viscosity whole grain flour slurry.

12. The beverage of claim 11 wherein the beverage base is dairy-based, fruit-based, or soy-based.

13. The beverage of claim 11 wherein the flour to water ratio may be about 1:8 to about 1:20.

14. The beverage of claim 11 comprising from about 0.1 to about 20 grams whole grain per 8 oz serving.

15. The beverage of claim 14 comprising from about 8 grams to about 16 grams whole grain per 8 oz serving.

16. The beverage of claim 11 wherein the whole grain flour is whole oat flour.

17. The beverage of claim 11 wherein the high shear treatment is emulsification.
